(19) United States
(12) Patent Application Publication
(10) Pub. No.: US 2026/0321059 A1
(43) Pub. Date: Oct. 15, 2026

(54) DEVICE FOR IRIS RECOGNITION WHEN PASSING

(71) Applicant: Veridos GmbH, Berlin (DE)

(72) Inventors: Simone FERSTL, Berlin (DE); Jindrich KODL, Berlin (DE); Armin REUTER, Berlin (DE); Susanne KRAENKL, Berlin (DE)

(73) Assignee: Veridos GmbH, Berlin (DE)

(21) Appl. No.: 19/478,782

(22) PCT Filed: Apr. 25, 2024
(86) PCT No.: PCT/EP2024/061433

§ 371 Date: Oct. 24, 2025

(30) Foreign Application Priority Data
Apr. 27, 2023 (DE) 10 2023 110 954.5

(51) Int. Cl. G06V 40/18; G03B 17/56; G06V 40/19; H04N 23/11; H04N 23/56; H04N 23/611; H04N 23/695; H04N 23/90

(52) U.S. Cl. CPC G06V 40/197; G03B 17/561; G06V 40/19; H04N 23/11; H04N 23/56; H04N 23/611; H04N 23/695; H04N 23/90; G06V 2201/07

(57) ABSTRACT

The disclosure relates to a device for iris recognition during passing, comprising a first iris camera with a first field of view and a first focal plane, a second iris camera with a second field of view and a second focal plane, a scene camera with a third field of view, and a controller. The first iris camera and the second iris camera are height adjustable. The first iris camera, the second iris camera, and the scene camera are in communication with the controller. The controller is configured to capture, via the scene camera, images of a person to be identified located outside a combined capture region of the first iris camera and the second iris camera, to determine, based on the captured images of the scene camera, a height of a periocular face region of a person to be identified, to adjust a height of the first iris camera and the second iris camera (20) in response to the determined height of the periocular face region such that the first iris camera and the second iris camera can capture the periocular face region, and to capture the periocular face region with the first iris camera and the second iris camera and to determine, based on the captured periocular face region, an identity of the person to be identified.

### CROSS REFERENCE TO RELATED APPLICATIONS

This application is a national stage filing under 35 U.S.C § 371 of International Patent Application No. PCT/EP2024/061433 filed Apr. 25, 2024, which was published under PCT Article 21(2) and claims priority to DE Application No. 10 2023 110 954.5 filed Apr. 27, 2023, and which are all hereby incorporated in their entirety by reference.

### FIELD

The present disclosure relates to a device for iris recognition of a person during passing.

### BACKGROUND

For verification of an authorization to enter or for other identification of a person, in general, for example, biometric features such as fingerprints, voice recognitions or an iris recognition, etc. can be carried out.

In general, in the case of an iris recognition, the eyes of a person are captured in the form of individual images or within an image of the entire periocular face region (i.e. the eye region of the person) and then a match of the iris features of the person with stored data is carried out. These images of the person to be identified can be recorded, for example, in a stationary device with a corresponding camera. Such an identity check in a stationary device is, however, time-consuming and not particularly comfortable, since the person to be identified cannot simply continue, but rather must first stop at the stationary device and look into the camera.

Another possibility of iris recognition is the monitoring of a capture corridor, through which the person to be identified passes, with corresponding cameras and the capturing of the periocular face region of the person while the latter passes through the capture corridor. This type of iris recognition is obviously significantly faster and more comfortable, since the person passes through the capture corridor and is identified without stopping. Human behavior such as waving, averting the view from the cameras or reflections in glasses make it more difficult to capture suitable iris images for a successful identification of a person during passing.

Therefore, it is usually attempted in such devices to record as many sharp iris images as possible over the largest possible capture region of the person to be identified, in order to increase the probability of capturing at least one suitable image for iris recognition.

In such devices, which enable the iris recognition during passing, a single powerful camera, such as, for example, a 3D camera (e.g. a light field camera (plenoptic camera)), or a camera with an adjustable working distance/focal plane is usually used in order to enable the capturing of the iris at different distances from the camera while the person moves through the capture region. Such complicated systems, however, on the one hand limit the possible frame rate and therefore generate a smaller number of sharp images. In addition, the resulting images are often more susceptible to artifacts which impair the image sharpness. A high image sharpness is one of the central requirements for robust iris recognition.

### SUMMARY

Accordingly, an objective of the present disclosure is to provide a reliable system for iris recognition during passing which avoids complicated camera systems.

This objective is achieved by the subject matter of the independent claim. Exemplary embodiments result from the dependent claims and the following description.

According to one aspect, a device for iris recognition during passing is provided. The device comprises a first iris camera with a first field of view and a fixed first focal plane, a second iris camera with a second field of view and a fixed second focal plane, a scene camera with a third field of view, and a controller. The first iris camera and the second iris camera are height adjustable. The first iris camera, the second iris camera, and the scene camera are in communication with the controller. The controller is configured to capture, via the scene camera, images of a person to be identified located outside a combined capture region of the first iris camera and the second iris camera, to determine, based on the captured images of the scene camera, a height of a periocular face region of a person to be identified, to adjust a height of the first iris camera and the second iris camera in response to the determined height of the periocular face region such that the first iris camera and the second iris camera can capture the periocular face region, and to capture the periocular face region with the first iris camera and the second iris camera and to determine, based on the captured periocular face region, an identity of the person to be identified.

In various aspects, the device according to the disclosure can, in particular, monitor a capture corridor (as described further below) through which persons to be identified pass. The capture corridor can be, for example, a correspondingly guided hallway or path which guides the person to be identified past the first iris camera, the second iris camera, and the scene camera. In general, however, the capture corridor only describes the functionally capturable region of the camera arrangement used and does not necessarily have to be physically separated (for example, by corresponding barriers).

In various aspects, the scene camera, the first iris camera, and the second iris camera are each cameras which have a fixed focal plane, i.e., a fixed working range/working distance from the camera.

In various aspects, the scene camera monitors, in particular, a region outside a combined capture region of the first iris camera and the second iris camera and thus, in particular, also the entire region at an entrance or around the entrance of a capture corridor, as described further below. This also means, in particular, the region outside the capture corridor and the region between the entrance of the capture corridor and the combined capture region of the first iris camera and the second iris camera. However, the scene camera can, of course, additionally also cover the combined capture region of the first iris camera and the second iris camera. When an identification process is initiated (for example, when a person enters the monitoring corridor or when such an identification process is manually started), the scene camera captures images of the entering person and transmits these images to the controller.

In various aspects, the controller can be any suitable control device, such as, for example, a general-purpose computer with corresponding memory and processor components, an ASIC, an FPGA, or any other suitable control device or combination of such control devices.

In various aspects, the controller extracts, from the images of the scene camera, the height of the periocular face region of the person to be identified, which passes through the monitoring corridor. In particular, the scene camera can have a focus region in the surroundings of an entrance of the monitoring corridor, such that sharp images of the person to be identified can be recorded at this position. However, the scene camera can, in principle, also record images of the person to be monitored at other locations along the monitoring corridor. The image sharpness of the scene camera is not an excessively limiting factor, since the scene camera merely undertakes the task of enabling the controller to determine the height of the periocular face region, i.e. to enable a rough alignment of the system (in particular of the first iris camera and the second iris camera). The images of the scene camera therefore only have to be qualitatively good enough to enable such a height determination. As is readily apparent, however, no excessively sharp images are necessary for this purpose.

In various aspects, the scene camera transmits the captured images to the controller, which determines, with corresponding image evaluation algorithms, the periocular face region of the entering person, i.e. the height thereof, on the basis of the recorded image material.

In various aspects, the first iris camera and the second iris camera, in turn, are intended to record the actual images used/necessary for iris recognition. For this purpose, the first iris camera and the second iris camera each have a corresponding field of view and a corresponding focal plane. In general, the field of view of a camera respectively describes the angular range which is captured by the corresponding camera. The focal plane, in turn, describes a distance in front of the respective camera at which the sharpest images are recorded. In general, the focal plane is defined by the focal length of the respective camera.

In various aspects, the first iris camera and the second iris camera are each cameras with a fixed focal plane and preferably with a small field of view, so that images can be recorded without great distortions. In the case of a large field of view, in addition, a high number of pixels of an image sensor of the camera is necessary in order to enable the necessary resolution for extraction of the corresponding features (e.g. iris features). Accordingly, iris cameras with a small field of view enable the use of image sensors with a smaller number of pixels. The first iris camera and the second iris camera are preferably cameras which have a high frame rate, in particular a frame rate of at least 10 images per second (fps).

In various aspects, in addition, the first iris camera and the second iris camera are height adjustable, so that the recording height of the first iris camera and the second iris camera can be adapted. Thereby, this height adjustability can be achieved in any conceivable way. For example, the first iris camera and the second iris camera can be mounted on separate height-adjustable mounts or on a common height-adjustable mount, as described further below, which can be driven by the controller. However, it is also conceivable that the iris cameras themselves are mounted on a fixed position and only their capture region (for example, by a mechanism or an optical system) can be adapted.

In various aspects, after determining the height of the periocular face region of the person to be identified with the scene camera, the controller adapts the height of the first iris camera and the second iris camera to the height of the periocular face region of the person to be identified previously determined on the basis of the images of the scene camera. This height adjustability enables in particular the use of cameras with a small field of view, since the camera is shifted or adjusted to the eye height (i.e. to the height of the periocular face region) of the person to be identified and can thus capture the periocular face region even with a small field of view.

By the use of two iris cameras each with a fixed focal plane, different distances in front of the camera arrangement (i.e. in front of the first iris camera and the second iris camera) can be recorded sharply or at least sharply enough for extraction of the iris features. This enables the iris recognition of the person to be identified with simple cameras with fixed focal planes, i.e., with fixed focal lengths or working distances in front of the camera, while the person to be identified passes along the capture corridor. In particular, complicated camera systems, such as plenoptic cameras or other refocusable cameras, are avoided by this arrangement. As a result, the first iris camera and the second iris camera can additionally be operated with a high frame rate, so that the probability of a successful identification is significantly increased. Furthermore, by eliminating unnecessary complexity, a more robust overall system with a greater reliability is achieved.

In various aspects, the disclosed device therefore uses a scene camera with a wide field of view and two or more iris cameras, preferably each with a smaller field of view, and with fixed focal planes. The scene camera performs a rough capture of the periocular face region, or the height thereof, of a person to be identified. The heights of the iris cameras (i.e. the capture heights thereof) are then adapted to the height of the periocular face region and images of the periocular face region are recorded while the person passes through a corresponding capture corridor. Image data or characteristics of the iris of the user to be identified can then be extracted therefrom, which, in turn, are used for identifying the person. The disclosed device enables the use of simple cameras with fixed focal planes as iris cameras. The probability of a successful identification is increased by the increased frame rate and the sharper images associated therewith. The use of a plurality of cameras in this case enables the identification while the person to be identified moves along the capture corridor.

The disclosed device enables, for example, an identity determination for the purpose of an access control or any other identity determination detached therefrom. For example, in the case of an access control, a door or a gate can be opened automatically if an authorized person has been identified. However, the controller can also have a display which outputs a determined identity, for example to a security employee. Exemplary applications are, for example, an identity determination in airports, railway stations, court buildings, company buildings, etc. However, this list is only exemplary.

It should be noted that, although described herein with two iris cameras, the disclosed device can also have more than two iris cameras, for example three, four, five, or any desired number of iris cameras.

According to one embodiment, the device for iris recognition during passing further comprises a height-adjustable mount supporting the first iris camera and the second iris camera and being in communication with the controller. The controller is configured to adjust the height of the first iris camera and the second iris camera by driving the height-adjustable mount accordingly.

The height-adjustable mount can be, for example, a linear actuator or another motor or a similar device on which the first iris camera and the second iris camera are mounted. For example, such a linear actuator can be represented by a motorized height-displaceable holder on a corresponding column on which the iris cameras are mounted. However, this is only one example. Any height-adjustable mount can be provided which enables a height change of the iris cameras.

In addition, instead of mounting both iris cameras on a common height-adjustable mount, each of the iris cameras can also be mounted on its own height-adjustable mount. If more than two iris cameras are provided, all of the iris cameras can be mounted on a common height-adjustable mount, or each iris camera can be mounted on its own height-adjustable mount. In addition, only some of the iris cameras can then also each be mounted on a common mount.

According to a further embodiment, the device for iris recognition during passing further comprises a strobe light operating in a near-infrared range. The controller is configured to drive the strobe light during capturing the periocular face region with the first iris camera and the second iris camera such that the strobe light emits light pulses during capturing the periocular face region.

The light pulses facilitate the recognition of the iris features if they strike the eyes of the person to be identified at the same time as the images are captured by the iris cameras. For safety reasons, the eyes of a person may only be irradiated with a certain amount of energy of the light per unit of time. The use of a strobe light enables an increase in the light intensity without the permissible light energy introduced into the eyes being exceeded on average over time.

It is also conceivable that a continuous distance measurement takes place during operation of the strobe light (for example, by means of a laser distance measurement, infrared distance measurement or any other suitable distance measurement) and the light intensity is adapted based on the distance in order not to exceed a maximum permissible light intensity in the eyes. The light intensity would then therefore decrease as the distance decreases.

According to a further embodiment, the light pulses are synchronized with the image capturing by the first iris camera and the second iris camera.

By synchronizing the light pulses with the image capture, it is ensured that the iris of the person to be identified is illuminated by the iris cameras during each image capture and the iris features can thus be better recognized and extracted.

According to a further embodiment, the third field of view is larger than the first field of view and than the second field of view.

Since the scene camera (to which the third field of view is assigned) serves to recognize the periocular face region and to align the iris cameras to the height thereof, the latter must capture a larger angular range. In principle, however, a smaller field of view leads to fewer image distortions, for example as a result of chromatic aberrations, excessive barrel-shaped distortions, blurring of corners, and vignetting. Since, however, the scene camera merely serves for rough alignment to the height of the periocular face region, such distortions are less decisive here. In order to identify the iris features, however, a capture of the periocular face region and thus of the iris of the person to be identified that is as realistic as possible is desirable. The iris cameras therefore have a smaller field of view, which enables a more detailed capture of the iris and the use of an image sensor with a smaller number of pixels.

According to a further embodiment, the controller is configured to capture the periocular face region with the first iris camera and the second iris camera while the person to be identified moves through a capture corridor.

According to a further embodiment, the first iris camera has a first depth of field and the second iris camera has a second depth of field.

The depth of field is a measure for the extent of the sharp region in the object space of an imaging optical system, such as, for example, a camera. The depth of field thus describes the size of the distance range of a camera, within which an object is imaged sufficiently sharply. Since the sharpest imaging is present in the focus region or the focal plane, a large depth of field means a large region around the focal plane, which is imaged in focus.

The first iris camera and the second iris camera can both have the same depth of field or different depths of field. The sharpness region defined thereby, however, additionally depends on the position of the focal plane. The sharpness region (described further below as capture volume) of the first iris camera and the second iris camera can thus differ from each other, even if both iris cameras have the same depth of field. It is thereby made possible, by the first and the second iris camera (and potentially by further iris cameras), to capture different regions in focus along the capture corridor, such that, together, sharp images of the periocular face region can be recorded over a larger region than by an iris camera alone.

According to a further embodiment, the first focal plane and the first depth of field define a first capture volume and the second focal plane and the second depth of field define a second capture volume. The first capture volume and the second capture volume each represent spatial volumes in front of the respective one of the first iris camera and the second iris camera, which are respectively imaged in focus by the respective one of the first iris camera and the second iris camera.

According to a further embodiment, the first capture volume and the second capture volume are different from each other at least in sections.

In particular, the first capture volume and the second capture volume can lie one behind the other in the direction of the capture corridor, such that each of the first iris camera and the second iris camera can image different regions in focus along the capture corridor. It is thereby made possible to record sharp images of the periocular face region over a larger region than by a single iris camera alone. The captured data record and thus the probability of a successful identification are thus increased.

Since the first iris camera and the second iris camera are aligned to the same height (the height of the periocular face region) during an identification process, the capture volumes have substantially the same extent in the vertical direction, unless the first field of view of the first iris camera and the second field of view of the second iris camera differ from each other. However, it is also conceivable that the first capture volume and the second capture volume differ from each other in height to a limited extent, as long as it is ensured that the periocular face region can be captured by both iris cameras.

The fact that the first capture volume and the second capture volume are different from each other at least in sections means, in particular, that an overlap region can also be present between the capture volumes (in particular along the capture corridor, i.e. along a horizontal distance from the iris cameras), which is imaged in focus both by the first iris camera and by the second iris camera. A continuous sharp image capture along the first capture volume and along the second capture volume is thus enabled.

According to a further embodiment, the first capture volume and the second capture volume lie one behind the other in the capture corridor through which the person to be identified moves during the iris recognition.

The capture corridor runs towards the first iris camera and the second iris camera at least in the region of the first and the second capture volume, such that the person to be identified moves towards the first and the second iris camera at least in sections in the capture corridor.

According to a further embodiment, the first iris camera, the second iris camera, and the scene camera are each non-plenoptic cameras.

As already indicated in the background of the disclosure, plenoptic cameras (also referred to as light field cameras) are powerful cameras that can achieve a higher depth of field. Since such camera systems, however, reduce the frame rate due to the large amount of data and thus generate a smaller number of sharp images, the disclosed device avoids such cameras and instead uses a plurality of simple cameras with fixed focal planes, which are preferably different from one another. A high frame rate with a simultaneously large sharp capture region is thereby enabled.

According to a further embodiment, the device for iris recognition during passing further comprises a recognition device in communication with the controller and configured to recognize the entry of the person to be identified into the capture corridor and to initiate an identification process in response thereto.

An identification process can thus be initiated automatically by the controller if the recognition device recognizes that a person to be identified enters the capture corridor.

It should be noted, however, that an identification process can also start manually, for example, by actuating a corresponding input device.

According to a further embodiment, the recognition device comprises at least one of a light barrier, an NFC device, an infrared distance sensor, and a motion detector mounted at an entrance of the capture corridor.

In the case of an infrared distance sensor, the identification process can be started automatically, for example, depending on a distance of the person to be identified.

A light barrier or a motion detector can recognize, for example, when a person enters or approaches the capture corridor, whereupon the controller can automatically start an identification process.

An NFC device can recognize, for example, when a transponder (such as, for example, an employee transponder carried by an employee who wants to enter a corresponding region) approaches and then start an identification process. In particular, when the identification is carried out for checking an authorization to enter, such a transponder can implement an additional security layer together with an NFC device, since the identification process is only started when a person who is in possession of such a transponder approaches. For example, the identification can then start and, if the identification was successful, a gate or a door can be opened.

However, this list is only exemplary and other recognition devices are likewise conceivable.

According to a further embodiment, the device for iris recognition during passing further comprises a data storage with a database storing biometric features of the periocular face region of persons authorized to enter. The controller is configured to determine the identity of the person to be identified via a match with the database.

The data storage can be part of the controller, for example, or can be independent of the controller, but in communication with the controller. It is also conceivable for the data storage to be present in a cloud, so that a central database can be accessed from different locations. The database can contain, for example, data relating to iris features of persons or other biometric data, in particular of the periocular face region. Preferably, the database is encrypted in order to prevent or at least make more difficult an unauthorized access.

### BRIEF DESCRIPTION OF THE FIGURES

FIG. 1 shows a device for iris recognition during passing with a user to be identified who is about to enter a capture corridor, wherein the set height of the first and the second iris camera is too high to capture the periocular face region of the user.

FIG. 2 shows the device from FIG. 1 shortly after the person to be identified has entered the capture corridor and after the height of the iris cameras has been adapted.

FIG. 3 shows the device from FIGS. 1 and 2 after the height of the iris cameras has been adapted to the height of the periocular face region of the person to be identified and while the second iris camera records an image of the periocular face region.

FIG. 4 shows an exemplary image of a periocular face region as recorded by the first and the second iris camera.

### DETAILED DESCRIPTION OF EXEMPLARY EMBODIMENTS

The illustrations in the figures are schematic and not true to scale. If the same reference numerals are used in different figures in the following description of the figures, these denote the same or similar elements. However, the same or similar elements can also be denoted by different reference numerals.

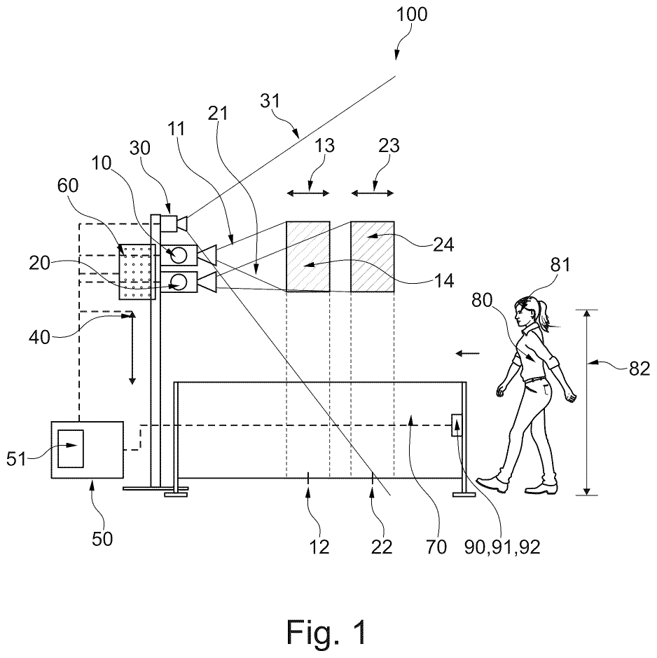

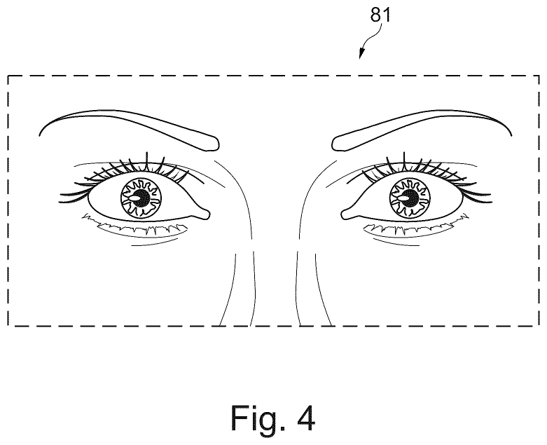

FIG. 1 shows an exemplary device 100 for iris recognition during passing. The device 100 serves to identify a person 80 to be identified via the capture of a periocular face region 81 (see FIG. 4) of the person 80 to be identified.

The device 100 comprises a scene camera 30, a first iris camera 10, a second iris camera 20, a strobe light 60, a controller 50 with a memory 51, and a recognition device 90, which can be embodied, for example, as a light barrier 91 or as an NFC device 92 (or also other suitable devices such as, for example, motion detectors, infrared distance sensors, etc.). The first iris camera 10, the second iris camera 20, and the strobe light 60 are also mounted on a common height-adjustable mount 40. Optionally, the scene camera can also be mounted on the height-adjustable mount 40. The first iris camera 10, the second iris camera 20, the scene camera 30, the strobe light 60, the recognition device 90, and the height-adjustable mount 40 are each in electronic communication with the controller 50. The controller 50 receives and/or transmits signals to each of these devices 10, 20, 30, 40, 60, 90 and thus controls the operation of the device 100.

The first iris camera 10 is a camera with a first field of view 11 and a fixed first focal plane 12 and the second iris camera 20 is a camera with a second field of view 21 and a fixed second focal plane 22. The first iris camera 10 has a first depth of field 13 and the second iris camera 20 has a second depth of field 23.

A “fixed” focal plane generally describes a focal plane which is not displaceable. The first iris camera 10 and the second iris camera 20 are thus in particular not refocusable cameras and in particular not plenoptic cameras (light field cameras) and not cameras with liquid lenses, but cameras with a fixed focal plane.

The field of view of a camera generally defines the angular range which can be captured by the respective camera. Accordingly, the first field of view 11 defines an angular range which the first iris camera 10 captures and the second field of view 21 defines an angular range which is captured by the second iris camera 20.

The focal planes 12, 22 of the first iris camera 10 and the second iris camera 20 define a distance in front of the respective iris camera 10, 20, which is imaged most sharply. In general, the focal plane of a camera coincides with its focal length.

The depths of field 13, 23 of the iris cameras 10, 20, in turn, describe (as described further above generally with respect to cameras) the size of a distance range in front of the respective camera, within which an object is imaged sufficiently sharply. In general, the regions defined by the depths of field 13, 23 each extend from a plane between the corresponding focal plane 12, 22 of the corresponding iris camera 10, 20 and the corresponding iris camera 10, 20, to a plane which is located further outward (i.e., further away from the camera) than the corresponding focal plane 12, 22 of the corresponding iris camera 10, 20. The depths of field thus define a region around the focal planes 12, 22 of the iris cameras 10, 20, which is imaged sufficiently sharply in order to extract the necessary image information, here for iris recognition or recognition of other biometric features of the periocular face region 81.

The first focal plane 12 and the first depth of field 13 thus define (of course together with the first field of view 11) a first capture volume 14 of the first iris camera 10. The second focal plane 22 and the second depth of field 23, in turn, define (together with the second field of view 21) a second capture volume 24 of the second iris camera 20. The first capture volume 14 and the second capture volume 24 thus each define a spatial volume in front of the corresponding iris camera 10, 20, in which a sufficiently sharp image capture for iris recognition is possible.

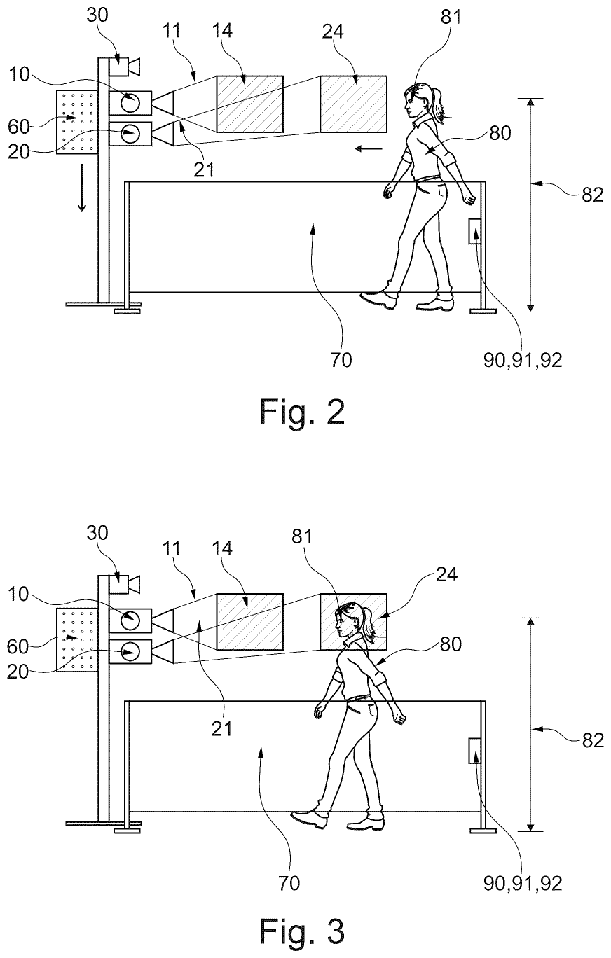

The first capture volume 14 and the second capture volume 24 lie one behind the other in FIG. 1 (and also FIGS. 2 and 3). A sharp image capture along a larger region along a capture corridor 70 with iris cameras 10, 20 with fixed focal planes 12, 22 (i.e., focal lengths) is thereby enabled. No complicated refocusable camera systems, such as, for example, plenoptic cameras, are used which produce high data rates. Since no such refocusable camera systems are used, the frame rate of the iris cameras 10, 20 can be higher, whereby an accurate iris recognition is enabled when passing through the capture corridor 70 with simple iris cameras 10, 20 over a large region along the capture corridor 70.

The first capture volume 14 and the second capture volume 24 lie one behind the other in FIGS. 1 to 3 and are spaced apart. It should be noted, however, that the capture volumes 14, 24 can also partially overlap in order to enable a continuous sharp image capturing by the two capture volumes 14, 24. In addition, it should be noted that the arrangement with two iris cameras 10, 20 is merely exemplary and more than two iris cameras 10, 20 can also be present, in order to further enlarge the entire capture volume and thereby increase the probability of a successful identification.

The scene camera 30 has a third field of view 31 which is larger than the first field of view 11 of the first iris camera 10 and than the second field of view 21 of the second iris camera 20. The scene camera 30 thus captures a larger angular range in front of the camera than the iris cameras 10, 20 and serves, in particular, for rough alignment of the device 100 to the periocular face region 81 during an identification process, as described further below.

A smaller field of view (i.e. a smaller captured angular range in front of the camera) is generally associated (as described further above) with fewer image distortions, but supplies a less large image section. In addition, a small field of view has the advantage that image sensors with a lower pixel density can be used and nevertheless the necessary pixel resolution is achieved. Since the first iris camera 10 and the second iris camera 20 serve to capture the periocular face region 81 and the captures of the periocular face region 81, in turn, are used for iris recognition and thus for identification, as small an image distortion as possible and high resolution are desirable here in order to be able to extract the information necessary for identification from the image data. The first iris camera 10 and the second iris camera 20 therefore have smaller fields of view 11, 21 than the scene camera 30.

The scene camera 30 captures, after an identification process has been started, a (preferably two-dimensional) “scene image” which comprises the person 80 to be identified and transmits corresponding image data to the controller 50. The controller 50 can then determine/identify a height 82 of the periocular face region 81 of the person 80 with corresponding image evaluation algorithms and using the known geometry of the camera system. For this purpose, the controller 50 can recognize, for example, structures in the images that are typical for a periocular face region 81. For example, the memory 51 of the controller 50 can contain corresponding comparison data and the controller 50 can also use machine learning algorithms. However, all other conceivable and suitable image evaluation algorithms are also possible. The height determination can also be based on a calibration or a mathematical model, for example, which are stored in the data storage 51 and allow an assignment of a specific position on the scene image to a specific height.

FIG. 1 shows the device 100 together with a person 80 to be identified before an identification process of the person 80 has been initiated. In this case, the height of the first iris camera 10 and the second iris camera 20 (i.e. in particular the height of the capture volumes 14, 24) is too high to capture the periocular face region 81 of the person 80.

An identification process can be carried out, for example, manually, e.g. by actuating a corresponding switch or button, or, as represented in FIGS. 1 to 3, automatically by a recognition device 90. If the recognition device 90 is, for example, a light barrier 91 or an NFC device 92, the identification process can start, for example, when the person 80 passes the light barrier 91 or, for example, carries a transponder which can be recognized by an NFC device 92 and when the person 80 with the transponder passes the NFC device.

Since the iris cameras 10, 20 have a relatively small field of view 11 or 21, the capture heights of the iris cameras 10, 20 must be aligned to the height 82 of the periocular face region 81 in order to be able to capture images of the periocular face region 81. For this purpose, after the person 80 enters the capture corridor 70 or even before the person 80 enters the capture corridor 70, the scene camera 30 initially captures one or more images and the controller 50 determines, as described above, the height 82 of the periocular face region 81 on the basis of these image data. The controller 50 then adapts the height of the first iris camera 10 and the second iris camera 20 to the height 82 of the periocular face region 81, so that the iris cameras 10, 20 can capture images of the periocular face region 81. For example, for this purpose the first iris camera 10 and the second iris camera 20 can be mounted on a height-adjustable mount 40 (not explicitly represented) which can be, for example, a corresponding linear actuator or another device which displaces the iris cameras 10, 20 in height.

In FIGS. 1 to 3, an optional strobe light 60 is also provided which is configured to illuminate the periocular face region 81 during the image capture by the iris cameras 10, 20 and to stimulate the pupil reaction, so that the iris features can be clearly recognized and extracted on the images. In FIGS. 1 to 3, the strobe light 60 is also mounted on the height-adjustable mount 40 and can be displaced in height together with the iris cameras 10, 20. However, this is not absolutely necessary. The strobe light 60 can also be fixed in position, for example, and illuminate the entire capture corridor 70.

The scene camera 30 can be mounted fixed in height, or can likewise be height-adjustable and move with the iris cameras 10, 20, for example, when these are adjusted in height. In such configurations, the controller 50 also takes into account the respective height of the scene camera 30 in the height determination. The scene camera 30 does not necessarily have to be mounted in the immediate vicinity of the iris cameras 10, 20 (as represented in FIGS. 1 to 3), but can also be provided at other positions. It is merely important that the scene camera 30 can record the capture corridor 70 and that the viewing angle of the scene camera 30 enables a determination of the height of the periocular region 81.

In addition, it should be noted that the capture corridor 70 does not necessarily have to be a physically separated region, as represented in FIGS. 1 to 3, but generally describes the capture region of the device 100. Physical barriers are not necessarily necessary for this. However, during the identification, the person 80 has to face the iris cameras 10, 20 at least in the region of the capture volumes 14, 24 such that the iris cameras 10, 20 can record images of the periocular face region 81.

In FIGS. 2 and 3, some elements and reference numerals, such as the controller 50 with the memory 52 and the height-adjustable mount 40 from FIG. 1, have been omitted for the sake of clarity.

FIG. 2 shows the device 100 from FIG. 1 after the person 80 to be identified has entered the capture corridor 70, the identification process has been started and the first iris camera 10 and the second iris camera 20 have been adjusted to the height 82 of the periocular face region 81, as described with reference to FIG. 1. The person 80 to be identified is still located in front of the first capture volume 14 and the second capture volume 24 in FIG. 2, but moves toward the capture volumes 14, 24. In this section, optionally first (after completion of the height adjustment of the iris cameras 10, 20 and possibly of the strobe light 60) no further action of the device 100 takes place.

FIG. 3 shows the device 100 after the person 80 to be identified has entered the second capture volume 24. At least from this point in time, the controller 50 instructs the first iris camera 10 and the second iris camera 20 to start with the image capturing. However, the controller 50 can also continuously capture image data with the iris cameras 10, 20 already from the start of the second section represented in FIG. 2 (i.e. after the person 80 has entered the capture corridor 70). The necessity of a further position determination of the person (e.g. by a further light barrier or in another way) in order to determine when the image capture is to start is thereby eliminated. The controller can then discard, for example, images which do not have a recognizable periocular face region 81. In addition, the controller 50 instructs the strobe light 60 to illuminate the capture volumes 14, 24 with strobe-like light pulses. The person 80 thus passes through the first capture volume 14 and the second capture volume 24, while the corresponding iris camera 10, 20 records images of the periocular face region 81 and transmits them to the controller 50. The strobe light can optionally be synchronized with the image capturing by the iris cameras 10, 20, so that a light pulse is always output when an image is being recorded by one of the iris cameras 10, 20. It is thereby ensured that each image is sufficiently illuminated and the iris features can be extracted from the images of the periocular face region 81.

The controller 50 then extracts the iris features from the images recorded by the iris cameras 10, 20 and compares them with corresponding comparison data in a database in order to determine an identity of the person 80 to be identified. The database can be stored in the data storage 51, for example. The comparison data can, however, also be stored in a centralized cloud memory, for example, so that a use by devices 100 at different locations is enabled. Independently of the type of memory, the comparison data are preferably stored encrypted in order to prevent an abuse by an unauthorized reading of the comparison data.

The device 100 can additionally be integrated into a more comprehensive system. If the identity determination is carried out, for example, for access control, the device 100 (or the controller 50 thereof) can be in communication with a door mechanism and, for example, open a door, a gate, a barrier automatically if the determined identity corresponds to a person authorized to enter. However, any other application for identity determination is also conceivable.

FIG. 4 shows a typical image of a periocular face region 81. In such a capture, the eyes and in particular the iris are clearly recognizable, so that these biometric features can be used for identification of the person 80, as described above.

In general, it should be noted that the identification can take place not only on the basis of the iris features, but, for example, can also take into account or at least take into account other biometric face features of the periocular face region 81, such as, for example, corresponding structures of the eye region.

### LIST OF REFERENCE NUMBERS

10 first iris camera
11 first field of view
12 first focal plane
13 first depth of field
14 first capture volume
20 second iris camera
21 second field of view
22 second focal plane
23 second depth of field
24 second capture volume
30 scene camera
31 third field of view
40 height-adjustable mount
50 controller
51 data storage
60 strobe light
70 capture corridor
80 person to be identified
81 periocular face region
82 height of the periocular face region
90 recognition device
91 light barrier
92 NFC device
100 Device for iris recognition

1. A device (100) for iris recognition during passing, the device (100) comprising:
a first iris camera (10) having a first field of view (11) and a fixed first focal plane (12);
at least one second iris camera (20) having a second field of view (21) and a fixed second focal plane (22);
a scene camera (30) having a third field of view (31); and
a controller (50);
wherein the first iris camera (10) and the second iris camera (20) are height adjustable;
wherein the first iris camera (10), the second iris camera (20), and the scene camera (30) are in communication with the controller (50);
wherein the controller (50) is configured to capture, via the scene camera (30), images of a person to be identified (80) located outside a combined capture region of the first iris camera (10) and the second iris camera (20);
wherein the controller (50) is configured to determine, based on the captured images of the scene camera (30), a height (82) of a periocular face region (81) of the person to be identified (80);
wherein the controller (50) is configured to adjust a height of the first iris camera (10) and the second iris camera (20) in response to the determined height (82) of the periocular face region (81) such that the first iris camera (10) and the second iris camera (20) can capture the periocular face region (81); and
wherein the controller (50) is configured to capture the periocular face region (81) with the first iris camera (10) and the second iris camera (20) and to determine, based on the captured periocular face region (81), an identity of the person to be identified (80).

2. The device (100) for iris recognition during passing according to claim 1, further comprising a height-adjustable mount (40) supporting the first iris camera (10) and the second iris camera (20) and being in communication with the controller (50);
wherein the controller (50) is configured to adjust the height of the first iris camera (10) and the second iris camera (20) by driving the height-adjustable mount (40) accordingly.

3. The device (100) for iris recognition during passing according to claim 1,further comprising a strobe light (60) operating in a near-infrared range;
wherein the controller (50) is configured to drive the strobe light (60) during capturing the periocular face region (81) with the first iris camera (10) and the second iris camera (20) such that the strobe light (60) emits light pulses during capturing the periocular face region (81).

4. The device (100) for iris recognition during passing according to claim 3, wherein the light pulses are synchronized with the image capturing by the first iris camera (10) and the second iris camera (20).

5. The device (100) for iris recognition during passing according to claim 1, wherein the third field of view (31) is larger than the first field of view (11) and than the second field of view (21).

6. The device (100) for iris recognition during passing according to claim 1, wherein the controller (50) is configured to capture the periocular face region (81) with the first iris camera (10) and the second iris camera (20) while the person to be identified (80) moves through a capture corridor (70).

7. The device (100) for iris recognition during passing according to claim 1, wherein the first iris camera (10) has a first depth of field (13); and
wherein the second iris camera (20) has a second depth of field (23).

8. The device (100) for iris recognition during passing according to claim 7, wherein the first focal plane (12) and the first depth of field (13) define a first capture volume (14);
wherein the second focal plane (22) and the second depth of field (23) define a second capture volume (24);
wherein the first capture volume (14) and the second capture volume (24) together form the combined capture region of the first iris camera (10) and the second iris camera (20) and each represent spatial volumes in front of the respective one of the first iris camera (10) and the second iris camera (20), which are respectively imaged in focus by the corresponding one of the first iris camera (10) and the second iris camera (20).

9. The device (100) for iris recognition during passing according to claim 8, wherein the first capture volume (14) and the second capture volume (24) are different from each other at least in sections.

10. The device (100) for iris recognition during passing according to claim 8, wherein the first capture volume (14) and the second capture volume (15) lie one behind the other in the capture corridor (70) through which the person (80) to be identified moves during the iris recognition.

11. The device (100) for iris recognition during passing according to claim 1, wherein the first iris camera (10), the second iris camera (20) and the scene camera (30) are each non-plenoptic cameras.

12. The device (100) for iris recognition during passing according to claim 1, further comprising a recognition device (90) in communication with the controller (50) and configured to recognize the entry of the person (80) to be identified into the capture corridor (70) and to initiate an identification process in response thereto.

13. The device (100) for iris recognition during passing according to claim 12, wherein the recognition device (90) comprises at least one of a light barrier (91), an NFC device (92), an infrared distance sensor, and a motion detector mounted at an entrance of the capture corridor (70).

14. The device (100) for iris recognition during passing according to claim 1, further comprising a data storage (51) with a database storing biometric features of the periocular face region (81) of persons authorized to enter, wherein the controller (50) is configured to determine the identity of the person to be identified (80) via a match with the database.

15. The device (100) for iris recognition during passing according to claim 9, wherein the first capture volume (14) and the second capture volume (15) lie one behind the other in the capture corridor (70) through which the person (80) to be identified moves during the iris recognition
